(19) United States
(12) Patent Application Publication
(10) Pub. No.: US 2019/0340607 A1
(43) Pub. Date: Nov. 7, 2019

(54) SYSTEM FOR CENTRAL AUTHORITY-PERMISSIONED TRANSFER OF BLOCKCHAIN TOKENS

(71) Applicant: Masterworks.io, LLC, New York, NY (US)

(72) Inventors: Scott William Lynn, Aspen, CO (US); Alberto Simon, Brooklyn, NY (US)

(73) Assignee: Masterworks.io, LLC, New York, NY (US)

(21) Appl. No.: 16/399,663

(22) Filed: Apr. 30, 2019

Related U.S. Application Data
(60) Provisional application No. 62/665,314, filed on May 1, 2018.

(51) Int. Cl. G06Q 20/38; G06Q 20/40; G06Q 20/36

(52) U.S. Cl. CPC G06Q 20/389; G06Q 20/4014; H04L 9/0643; G06Q 20/3829; G06Q 20/3678

(57) ABSTRACT

Embodiments of the present invention provide a system for central authority-permissioned transfer of blockchain tokens. In particular, the a request is received to transfer a set of blockchain tokens that represent an ownership share in a physical asset from a first user to a second user. Information about the first user and second user is compared to a central authority repository that comprises a listing of vetted users permitted to perform transactions with blockchain tokens associated with the physical asset to determine that the first and second users are verified. In response to determining that the first and second users are verified a transaction function is built for the transfer of the set of blockchain tokens from a digital wallet of the first user to a digital wallet of the second user. Finally, the transaction function is published to a blockchain network associated with the set of blockchain tokens.

### PRIORITY CLAIM

This application claims priority to U.S. Provisional Application Ser. No. 62/665,314, entitled “SYSTEM FOR CENTRAL AUTHORITY-PERMISSIONED TRANSFER OF BLOCKCHAIN TOKENS”, filed May 1, 2018, which is incorporated herein by reference in its entirety.

### BACKGROUND

The emergence of blockchain technology allows for robust and permanent recordation of token transfers. However, conventional blockchain technology does not require individuals and entities interacting with the blockchain to identify themselves apart from public or private keys that are associated with digital wallets that store and/or record blockchain tokens and/or transactions. This lack of transparency in the ownership of certain assets can be problematic in environments where the blockchain tokens are transferred as financial assets, as governmental regulatory bodies often require full disclosure of the identities and positions of owners of traded financial assets. Therefore, the inclusion of a central authority repository of known users that have been thoroughly vetted and are continuously monitored can enable an improved blockchain-based exchange system that meets strict security and regulatory standards.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for central authority-permissioned transfer of blockchain tokens. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve receiving a request to transfer a set of blockchain tokens that represent an ownership share in a physical asset from a first user to a second user. The system may then compare information about the first user to a central authority repository that comprises a listing of vetted users permitted to perform transactions with blockchain tokens associated with the physical asset to determine that the first user is verified. Additionally, the system may compare information about the second user to the central authority repository to determine that the second user is verified. In response to determining that the first user is verified, and in response to determining that the second user is verified, the system may build a transaction function for the transfer of the set of blockchain tokens from a digital wallet of the first user to a digital wallet of the second user. Finally, the system may publish the transaction function to a blockchain network associated with the set of blockchain tokens.

In some embodiments of the system, the request to transfer the set of blockchain tokens comprises a confidential passcode of the first user and a confidential passcode of the second user, wherein the confidential passcode of the first user is associated with a public and private key pair of the digital wallet of the first user, and wherein the confidential passcode of the second user is associated with a public and private key pair of the digital wallet of the second user.

Furthermore, in some embodiments of the system, the digital wallet of the first user is managed solely by a central authority entity, and wherein the digital wallet of the second user is managed solely by the central authority entity.

The request to transfer the set of blockchain tokens may, in some embodiments of the system, be received from a third party exchange system. In some such embodiments, the system may further transmit a notification to the third party exchange system indicating that the set of blockchain tokens has been transferred from the digital wallet of the first user to the digital wallet of the second user.

Comparing the information about the first user to the central authority repository to determine that the first user is verified may comprise, in some embodiments, determining that a received identity of the first user matches an identity of a vetted user stored within the central authority repository that meets regulatory requirements for trading the set of blockchain tokens.

Similarly, comparing the information about the second user to the central authority repository to determine that the second user is verified may further comprise determining that a received identity of the first user matches an identity of a vetted user stored within the central authority repository that meets regulatory requirements for trading the set of blockchain tokens.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a centralized database system;

FIG. 2 depicts a distributed electronic ledger system in accordance with an embodiment of the invention;

FIG. 3 depicts a blockchain in accordance with an embodiment of the invention;

FIG. 4 provides a block diagram illustrating a system environment for central authority-permissioned transfer of blockchain tokens in accordance with an embodiment of the invention;

FIG. 5 provides a block diagram illustrating the managing entity system of FIG. 4 in accordance with an embodiment of the invention;

FIG. 6 provides a block diagram illustrating the computing device system of FIG. 4 in accordance with an embodiment of the invention;

FIG. 7 provides a flowchart illustrating a process for generating and transferring blockchain tokens that represent an ownership interest in a physical asset in accordance with an embodiment of the invention;

FIG. 8 provides a flowchart illustrating a process for generating and transferring blockchain tokens that represent an ownership interest in a physical asset in accordance with an embodiment of the invention;

FIG. 9 provides a flowchart illustrating a process for facilitating a transfer of blockchain tokens between two users in accordance with an embodiment of the invention; and

FIG. 10 provides a flowchart illustrating a process for facilitating a transfer of blockchain tokens via a third party exchange system in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Embodiments of the present invention provide a system and method for central authority-permissioned transfer of blockchain tokens. A managing entity may acquire a physical asset such as an artwork, and generate a plurality of blockchain tokens that adhere to a smart contract to represent a fractional ownership stake in the physical asset. The managing entity can then issue the blockchain tokens to multiple users, allowing those users to have an ownership stake in the physical asset, and to trade their ownership stake (the blockchain tokens) with other users.

Importantly, the present invention also includes the use of a central authority repository that maintains an accurate listing of identities of each user that is permitted to purchase, own, trade, or otherwise interact with the blockchain tokens associated with the physical asset. Additionally, the managing entity system retains full control over the digital wallets associated with the blockchain tokens such that the managing entity is the only entity that can transfer the blockchain tokens. Such transfers are only executed if they meet conditions of regulatory institutions, the users in the transactions are vetted via the central authority repository, and the transfer adheres to the smart contract for the blockchain tokens. In this way, the present invention retains the stakeholder disclosure requirements of most regulatory and tax agencies, enabling this blockchain-based trading platform to meet regulatory standards that conventional blockchain trading platforms cannot meet due to their inherent lack of control and the possible anonymity of its traders.

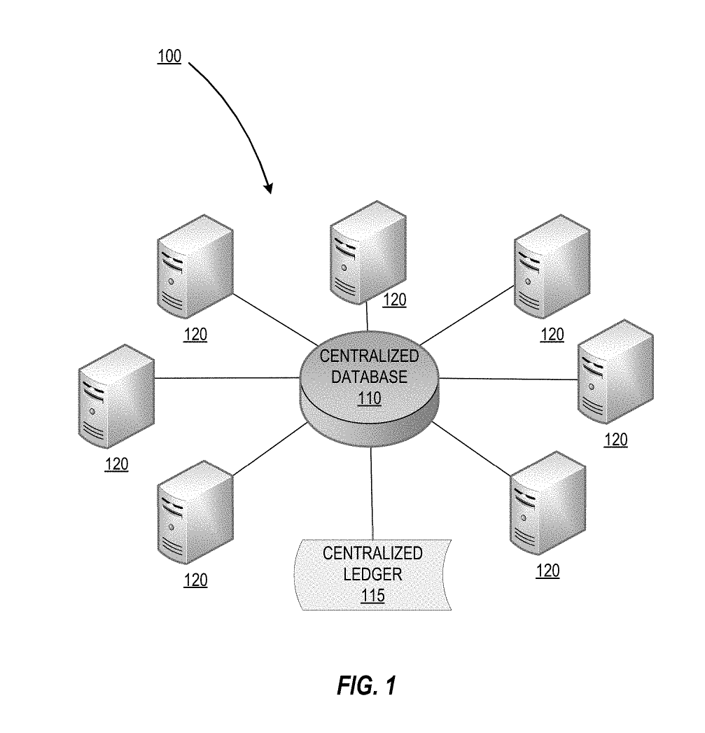

FIG. 1 is a symbol diagram illustrating a centralized database system 100 that may include a centralized database 110 that hosts a centralized ledger 115 or other centralized data. The centralized database 110 may be in operative communication over a network with one or more client systems 120 and is configured to allow the client systems 120 to access and interact with the data stored in the centralized ledger 115. The centralized database 110 may be operated by a managing entity and contain information regarding ownership stakes in a physical asset, as represented by shares or tokens of ownership. The client systems 120 may be third party exchanges, computing devices associated with the managing entity that perform initial coin or token offerings, token transactions, management of digital wallets, and the like. In addition to being in communication with the centralized database 110, each client system 120 may have a local token ownership database. As noted above, it is difficult to maintain consistency between the local token ownership databases and the centralized database 110.

However, in one aspect of the present invention a distributed ledger may be used to maintain information regarding ownership of tokens that represent an ownership stake in a physical asset. “Distributed ledger” or “distributed electronic ledger” as used herein may refer to a structured list of data records which is decentralized and distributed amongst a plurality of computing systems and devices.

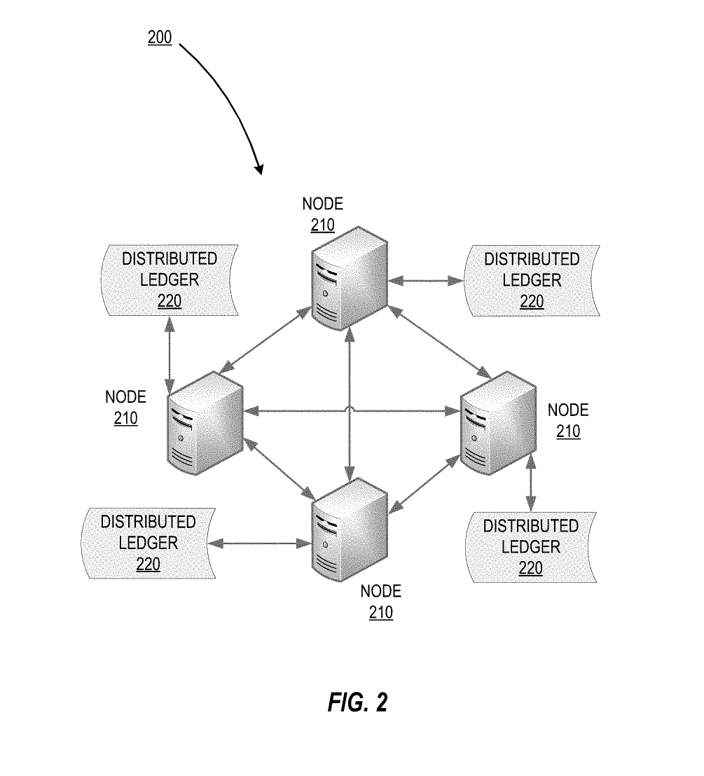

FIG. 2 is a symbol diagram illustrating a distributed electronic ledger system 200 including a distributed ledger 220 stored in a decentralized manner across a plurality of nodes 210, in accordance with some embodiments of the present invention. The distributed ledger 220 may be a blockchain. Each node 210 may be a computing device, which may be in operative communication with the other nodes 210 over a network. Each node may be a computing device, where one or more of which are owned, managed, or otherwise operated by a managing entity system that is configured to write to, publish to, or otherwise communicate with the other nodes 210 in the distributed electronic ledger system 200. Each node 210 may host a complete or partial copy of the distributed ledger 220.

When additional data records are proposed to be added to the distributed ledger 220, one or more (e.g., each) of the nodes 210 typically validate the proposed additional data records (e.g., via a consensus algorithm) to thereby determine whether the proposed data record should be added to the distributed ledger 220. Typically, once the proposed data record has been validated (e.g., through the consensus algorithm), the proposed data record is added to each copy of the distributed ledger 220 across all of the nodes 210.

Various types of consensus algorithms to ensure the integrity of the data within the distributed ledger. In some embodiments, validation of data records is part of the utilized consensus algorithm. In other embodiments validation of data records is independent of the consensus algorithm. A non-exhaustive description of exemplary consensus algorithms follows.

In some embodiments, the consensus mechanism may be a “proof of work” (“POW”) algorithm, in which the nodes perform a series of calculations to solve a cryptographic puzzle. For instance, in order to validate a pending data record, the nodes may be required to calculate a hash via a hash algorithm (e.g., SHAD256) that satisfies certain conditions set by the system. Calculating a hash in this way may be referred to herein as “mining,” and thus nodes performing the mining may be referred to as “miners” or “miner nodes.” The distributed ledger system may, for example, require the value of the hash to be under a specific threshold. In such embodiments, the nodes may combine a “base string” (i.e., a combination of various types of metadata within a block header, e.g., root hashes, hashes of previous blocks, timestamps, etc.) with a “nonce” (e.g., a whole number value) to be input into the POW algorithm to produce a hash. In an exemplary embodiment, the nonce may initially be set to 0 when calculating a hash value using the POW algorithm. The nonce may then be incremented by a value of 1 and used to calculate a new hash value as necessary until a node is able to determine a nonce value that results in a hash value under a specified threshold (e.g., a requirement that the resulting hash begins with a specified number of zeros). The first node to identify a valid nonce may broadcast the solution (in this example, the nonce value) to the other nodes of the distributed ledger for validation. Once the other nodes have validated the “winning” node's solution, the pending data record may be appended to the last block in the distributed ledger. In some cases, a divergence in distributed ledger copies may occur if multiple nodes calculate a valid solution in a short timeframe. In such cases, the nodes using the POW algorithm accept the longest chain of blocks (i.e., the chain with the greatest proof of work) as the “true” version of the distributed ledger. Subsequently, all nodes having a divergent version of the distributed ledger may reconcile their copies of the distributed ledger to match the true version as determined by the consensus mechanism.

In other embodiments, the consensus mechanism may be a “proof of stake” (“PoS”) algorithm, in which the validation of pending data records depends on a user's “stake” within the distributed ledger. For example, the user's “stake” may depend on the user's stake in a digital currency or point system (e.g., a cryptocurrency, token system, asset share system, reputation point system, etc.) within the distributed ledger. The next block in the distributed ledger may then be decided by the pending data record that collects the greatest number of votes. A greater stake (e.g., in a given digital currency or token system) results in a greater number of votes that the user may allocate to particular pending data records, which in turn increases the chance for a particular user to create blocks in the distributed ledger system.

In yet other embodiments, the consensus mechanism may be a “practical byzantine fault tolerance” (“PBFT”) algorithm, in which each node validates pending data records by using a stored internal state within the node. In particular, a user or node may submit a request to post a pending data record to the distributed ledger. Each of the nodes in the distributed ledger may then run the PBFT algorithm using the pending data record and each node's internal state to come to a conclusion about the pending data record's validity. Upon reaching said conclusion, each node may submit a vote (e.g., “yes” or “no”) to the other nodes in the distributed ledger. A consensus is reached amongst the nodes by taking into account the total number of votes submitted by the nodes. Subsequently, once a threshold number of nodes have voted “yes,” the pending data record is treated as “valid” and is thereafter appended to the distributed ledger across all of the nodes.

In some embodiments, the distributed ledger 220 allows data records to be appended but does not allow for direct modification of existing data records or any of the other data or metadata existing within the distributed ledger (e.g., blocks in a blockchain). In other embodiments, the distributed ledger 220 allows data records to be directly modified, but maintains a history of previous data record versions and the modifications that were made. Accordingly, the distributed ledger 220 may include all of the data records written to it since its creation. If a particular node 210 were to become unavailable (e.g., due to being offline, hardware failures, security breaches, and the like), the remaining nodes 210 will remain available to host a verified copy of the distributed ledger 220. Furthermore, if data records within the distributed ledger 220 hosted on a particular node 210 were to be deleted, modified, or otherwise compromised, the remaining nodes 210 may serve as references to determine the true version of the distributed ledger 220. In some embodiments, a compromised node 210 may be taken offline such that the corrupted ledger is inaccessible. In other embodiments, the compromised node 210 may automatically correct its copy of the distributed ledger 220 based on the distributed ledger 220 stored on the remaining nodes 210 via a consensus mechanism.

In some embodiments, the distributed ledger may be either unpermissioned or permissioned, and/or either public or private. A “public” distributed ledger may refer to a distributed ledger that is accessible to any member of the public, whereas a “private” distributed ledger may refer to a distributed ledger that is accessible only to users who meet a certain criteria (e.g., limited to employees of a particular entity or a consortium of entities). A “permissioned” distributed ledger may refer to a distributed ledger for which an access control mechanism is implemented such that only known, authorized users may take certain actions within the distributed ledger (e.g., contribute to consensus and/or validation), whereas an “unpermissioned” distributed ledger may refer to a distributed ledger without an access control mechanism. Accordingly, the distributed ledger may be an unpermissioned and public ledger, an unpermissioned and private ledger, a permissioned and public ledger, or a permissioned and private ledger.

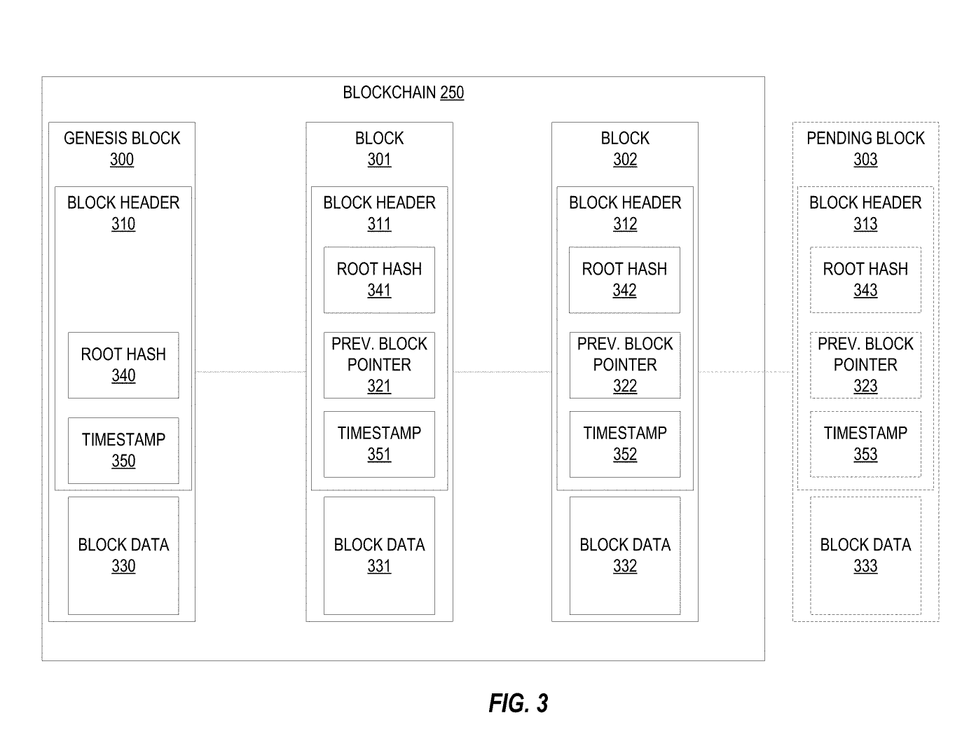

As noted herein, a distributed ledger may take the form of a blockchain. In this regard, FIG. 3 is a block diagram illustrating data structures of a blockchain 250 in detail, in accordance with some embodiments. In particular, FIG. 3 depicts a plurality of blocks 300, 301, and 302 contained in a blockchain 250, in addition to a proposed block 303 to be appended to the last block 302 in the blockchain. The blockchain 250 may include a genesis block 300 that serves as the first block in the blockchain. The genesis block 300, like all other blocks within the blockchain 250, include a block header 310 and block data 330. Each block data 330 within a block 300 may contain a wide range of different types of data records. For instance, in some embodiments, the block data 330 may include information related to an ownership breakdown of blockchain tokens that represent an ownership share in on or more physical assets. In this regard, the block data 330 may specify the permissions one or more users have to claim ownership rights in a particular physical asset, rights or permissions to purchase or sell the blockchains tokens that represent ownership rights in the particular physical asset, types of transactions of the blockchain tokens that can occur, smart contracts (e.g., solidarity smart contracts) or other sets of rules that need to be met for a blockchain token to be accepted in a transfer, and the like. The block data 330 may also include a digital signature (e.g. a personal identification number, a private key, a public key, an alphanumeric code, or the like) of a particular user or system that has executed a recorded transaction of blockchain tokens and/or been a party to the recorded transfer of blockchain tokens. In some embodiments, the block data 330 may a link to and/or has value of data contained in a database that exists outside the blockchain (e.g., a value that is tied to or otherwise derived from a physical asset).

The block header 310 may include various types of metadata regarding the block data 330. In some embodiments, the block header 310 may include a root hash 340, which is a hash derived from the block data 330. In some embodiments, the root hash 340 may be a Merkle root hash, wherein the root hash 340 is calculated via a hash algorithm based on a combination of the hashes of each transaction within the block data 330. In this way, any changes to the data within the block data 330 will result in a change in the root hash. The block header 310 may further include a timestamp 350 that indicates the time at which the block was written to the blockchain 250. In some embodiments, the timestamp may be a Unix timestamp. In some embodiments, particularly in blockchains utilizing a POW consensus mechanism, the block header 310 may include a nonce value and a difficulty value. The nonce value may be a whole number value that causes the hash of the block header 310 to satisfy the difficulty level of the cryptographic puzzle as defined by the difficulty value. For instance, the consensus mechanism may require that the resulting hash of the block header 310 metadata falls below a certain value threshold (e.g., the hash must start with a certain number of zeroes, as defined by the difficulty value).

A subsequent block 301 may be appended to the genesis block 300 to serve as the next block in the blockchain. Like all other blocks, the subsequent block 301 includes a block header 311 and block data 331. Similarly, the block header 311 may include a root hash 341 of the data within the block data 331 and a timestamp 351. The block header 311 may further include a previous block pointer 321, which may be a hash calculated by combining the hashes of the metadata (e.g., the root hash 340, timestamp 350, and the like) within the block header 310 of the genesis block 300. The block pointer 321 may be used to identify the previous block (i.e., the genesis block 300) in the blockchain 250. Of course, other types of previous block pointers and other methods of generating and storing a hash of a previous block could be used in a subsequent block in other types of distributed ledger implementations.

A subsequent block 302 may be appended to the block 301, where the subsequent block 302 also includes a block header 312 and block data 332. The block header 312 may also include a previous block pointer 322 that points to the previous block 301, where the previous block pointer 322 may be a hash value derived by combining the metadata within the block header 311 (including the previous block pointer 321) into a hash algorithm. The block pointer 322 may identify the previous block 301 in the blockchain 250.

In this way, the values of each previous block pointer 321, 322 within the blockchain are dependent on the hashes of the block headers of all of the previous blocks in the chain; if the block data within any of the blocks is altered, the block header for the altered block as well as all sub-sequent blocks will result in different hash values (i.e., the hash in the block header may not match the hash of the values within the block data), which may cause subsequent validation checks to fail. Even if an unauthorized user were to change the block header hash to reflect the altered block data, this would in turn change the hash values of the previous block pointers of the next block in the sequence. In other words, an unauthorized user who wishes to alter a data record within a particular block must also alter the hashes of all of the subsequent blocks in the chain in order for the altered copy of the blockchain to pass the validation checks imposed by the consensus algorithm. Thus, the computational impracticability of altering data records in a block-chain in turn greatly reduces the risk of improper alteration of data records.

A pending block 303 or “proposed block” may be submitted for addition to the blockchain. The pending block 303 may include a block header 313, which may include a root hash 343, a previous block pointer 323 that points to the block 302, a timestamp 353, and block data 333. Once a pending block 303 is submitted to the system, the nodes within the system may validate the pending block 303 via a consensus algorithm. The consensus algorithm may be, for instance, a proof of work mechanism, in which a node determines a nonce value that, when combined with a hash of the block header 312 of the last block in the blockchain, produces a hash value that falls under a specified threshold value. For instance, the POW algorithm may require that said hash value begins with a certain number of zeroes. Once said nonce value is determined by one of the nodes in the blockchain, the node may post the “solution” to the other nodes in the blockchain. Once the solution is validated by the other nodes, the hash of the block header 312 is included in the block header 313 of the pending block 303 as the previous block pointer 323. The block header 313 may further include the root hash 343 of the block data 333 which may be calculated based on the winning solution. The pending block 303 is subsequently considered to be appended to the previous block 302 and becomes a part of the blockchain 250. A timestamp 353 may also be added to signify the time at which the pending block 303 is added to the blockchain 250. In other embodiments, the consensus mechanism may be based on a total number of votes submitted by the nodes of the blockchain 250 (e.g., a PBFT consensus mechanism). Once a threshold number of votes to validate the pending block 303 has been reached, the pending block 303 may be appended to the blockchain 250. In such embodiments, nonce values and difficulty values may be absent from the block headers.

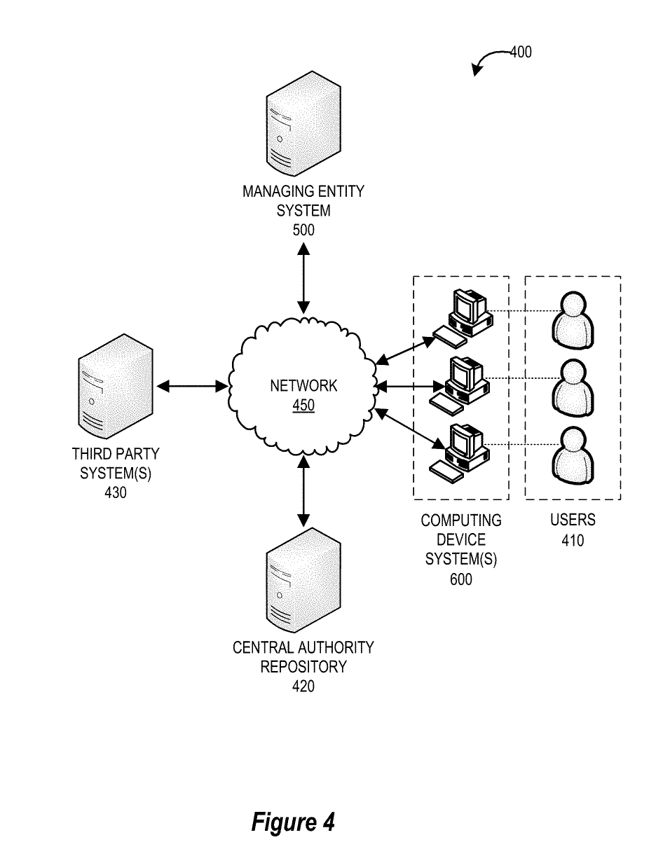

FIG. 4 provides a block diagram illustrating a system environment 400 for permissioned transfer of blockchain tokens, in accordance with an embodiment of the invention. As illustrated in FIG. 4, the system environment 400 includes a managing entity system 500, one or more computing device system(s) 600 associated with one or more users 410, a central authority repository 420, and one or more third party systems 430. One or more users 410 may be included in the system environment 400. In some embodiments, the user(s) 410 of the system environment 400 may be customers of the managing entity system 500, registered users of a program or application associated with the managing entity system 500, investors, traders, and/or the like.

The managing entity system 500, the computing device systems 600, and/or the third party systems 430 may be in network communication across the system environment 400 through the network 450. The network 450 may include a local area network (LAN), a wide area network (WAN), and/or a global area network (GAN). The network 450 may provide for wireline, wireless, or a combination of wireline and wireless communication between devices in the network. In one embodiment, the network 450 includes the Internet.

The managing entity system 500 may be a system owned or otherwise controlled by a managing entity (e.g., a central authority entity) to perform one or more process steps described herein. In some embodiments, the managing entity is a financial institution, an entity that specializes in distributing ownership shares in a physical asset and managing exchanges of the ownership shares over time, an entity that specializes in verifying exchanges of ownership shares in a physical asset across a third party exchange platform, and the like. In general, the managing entity system 500 is configured to communicate information or instructions with the computing device systems 600, the central authority repository 420, and/or the third party system 430 across the network 450.

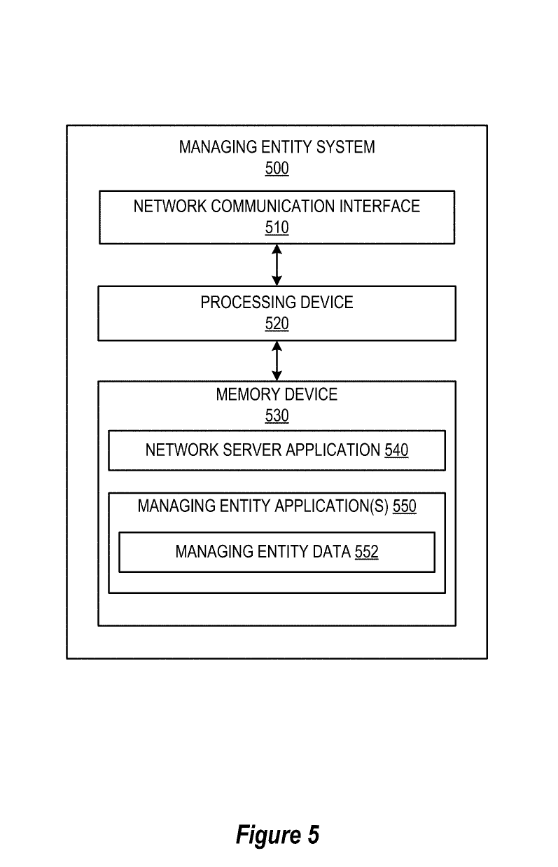

For example, the managing entity system 500 may establish an online portal that facilitates communications with the computing device systems 600. In some embodiments, the managing entity system 500 may be configured to compare information associated with buy or sale requests of blockchain tokens to data stored in the central authority repository 420 to validate transactions of the blockchain tokens. Furthermore, the managing entity system 500 may be configured to provide an application program interface to one or more third party exchanges (e.g., a third party system 430) that provides blockchain token transaction authentication, verification, validation, and confirmation to the third party exchanges. Of course, the managing entity system 500 may be configured to perform (or instruct other systems to perform) one or more other process steps described herein. The managing entity system 500 is described in more detail with respect to FIG. 5.

An “interface” exposes applications to human and application users via a human user interface (e.g., a graphical user interface) and/or an application programming interface (API). In this regard, an interface defines a facade that provides access to the capabilities that are implemented by application components behind the facade.

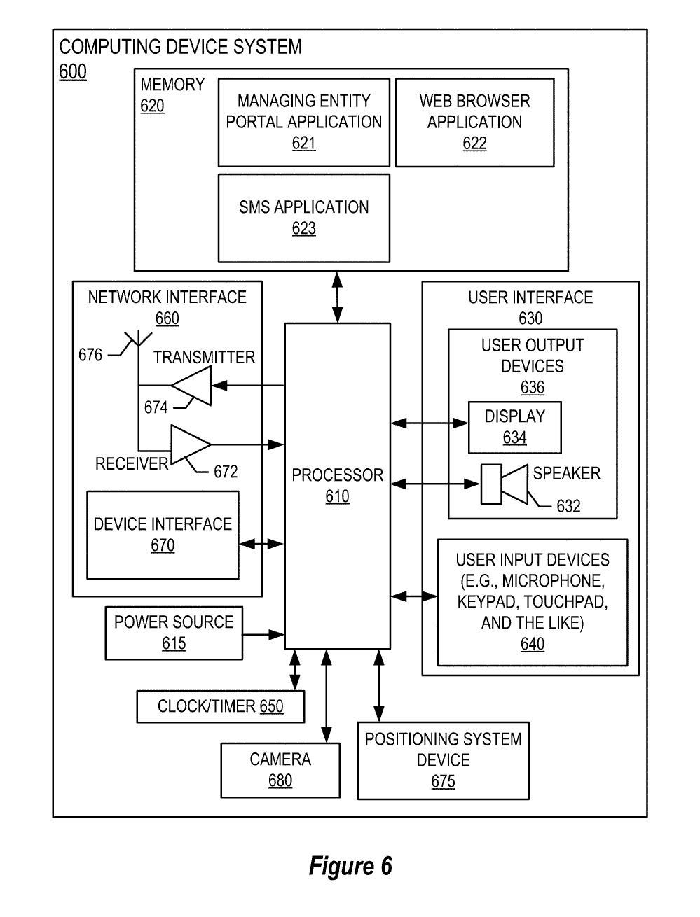

The computing device systems 600 may each comprise one or more computing devices that are associated with users 410 or customers of the managing entity system 500 and/or users 410 or employees of a third party system 430 (e.g., a regulator, a transaction manager, a know your customer process manager, or the like). In general, the computing device systems 600 are configured to communicate information or instructions with the managing entity system 500, the central authority repository 420, and/or the third party systems 430 across the network 450. For example, the computing device systems 600 may transmit blockchain token transaction requests to the managing entity system 500 and/or a third party exchange system (e.g., a third party system 430). Of course, the computing device systems 600 may be configured to perform (or instruct other systems to perform) one or more other process steps described herein. An detailed example of a computing device system 600 is described in more detail with respect to FIG. 6.

The central authority repository 420 may be a system owned or controlled by the managing entity and/or a third party that specializes in authorizing users for owning, purchasing, transferring, receiving, selling, storing, and/or managing blockchain tokens that are representative of an ownership interest in a physical asset. In general, the central authority repository 420 is configured to communicate information or instructions with the managing entity system 500, and/or the third party system 430 across the network 450. For example, the central authority repository 420 may serve as a database that the managing entity system 500 accesses, via the network 450, to compare an identity of a user that is party to a transaction request to information stored in the central authority repository 420 to determine whether the user is authorized to take part in the transaction. Of course, the central authority repository 420 may be configured to perform (or instruct other systems to perform) one or more other process steps described herein.

The third party system(s) 430 may be one or more systems, databases, applications, or the like that are configured to interact with the managing entity system 500, the computing device system(s) 600, and/or the central authority repository 420 via the network 450. One third party system 430 may comprise a know your customer service system that is configured to communicate with the managing entity system 500, the computing device systems 600, and/or the central authority repository 420 to verify or authenticate a purported identity of a user 410. Another third party system 430 may comprise a governmental agency system, such as a financial transaction regulatory body.

In some embodiments, the third party system 430 may comprise one or more third party exchange systems that are configured to market and/or facilitate trades or other transactions between two or more users 410 of blockchain tokens that represent an ownership share in a physical asset. In such embodiments, the third party system 430 may comprise one or more application program interfaces that are configured to request user 410 verifications, asset verifications, information regarding transaction permissions, and the like from the managing entity system 500. Likewise, the managing entity system 500 may comprise one or more application program interfaces configured to verify transaction requests or orders within the third party system 430 (i.e., a third party exchange system), and to confirm successful transfers of blockchain tokens from one managed digital wallet to another managed digital wallet as part of a transaction that is otherwise facilitated through the third party system 430.

FIG. 5 provides a block diagram illustrating the managing entity system 500, in greater detail, in accordance with embodiments of the invention. As illustrated in FIG. 5, in one embodiment of the invention, the managing entity system 500 includes one or more processing devices 520 operatively coupled to a network communication interface 510 and a memory device 530. In certain embodiments, the managing entity system 500 is operated by a first entity, such as a financial institution, while in other embodiments, the managing entity system 500 is operated by an entity other than a financial institution.

It should be understood that the memory device 530 may include one or more databases or other data structures/repositories. The memory device 530 also includes computer-executable program code that instructs the processing device 520 to operate the network communication interface 510 to perform certain communication functions of the managing entity system 500 described herein. For example, in one embodiment of the managing entity system 500, the memory device 530 includes, but is not limited to, a network server application 540, and one or more managing entity applications 550 that include managing entity data 552 and other computer-executable instructions or other data. The computer-executable program code of the network server application 540, and/or the managing entity applications 550 may instruct the processing device 520 to perform certain logic, data-processing, and data-storing functions of the managing entity system 500 described herein, as well as communication functions of the managing entity system 500.

In some embodiments, a managing entity application 550 may comprise a web portal application that is configured to facilitate interactions between the managing entity system 500 and the one or more computing device systems 600 of the one or more users 410. For example, the web portal application may be configured to receive and facilitate communication concerning registration requests, deposits of funds (both in fiat and in cryptocurrency), receive and facilitate communication concerning blockchain token purchases or trade requests, authentication of users 410, and the like.

One managing entity application 550 may comprise a digital wallet manager application that is configured to generate, manage, conduct transactions to and from, and otherwise control one or more digital wallets associated with each user 410. For example, the managing entity application 550 may generate a private and public key pair for a blockchain token system for each user 410, and associate a digital wallet with the private and public key pair. Additionally, in embodiments where the managing entity system 500 is facilitating a transaction of blockchain tokens from one user 410 to another user 410, the digital wallet manager application may be configured to execute instructions for transferring blockchain tokens from a digital wallet of a first user 410 to a digital wallet of a second user 410. The digital wallet manager application may further be configured to control, identify, or otherwise access one or more financial accounts of a user 410 such that funds can be transferred to or from the financial accounts of the user 410 based on transactions facilitated by the managing entity system 500.

Another managing entity application 550 may comprise a currency conversion application. The currency conversion application may be configured to access one or more currency exchange systems (e.g., a third party system 430) to identify conversion rates between different currencies, including real-time values of cryptocurrencies, foreign currencies, and the like. The currency conversion application may be configured to display currency values, real-time values of blockchain tokens that represent ownership interests in a physical asset, and the like via an online portal or another platform. The currency conversion application may, in some embodiments, be configured to utilize a currency exchange to convert a currency amount of one type of currency into a currency amount in another type of currency. For example, the managing entity system 500 may receive a payment in USD for a set of blockchain tokens that represent an ownership interest in a physical asset, but the managing entity system 500 is pairing the value of the blockchain tokens to a particular cryptocurrency. The currency conversion application may then exchange the payment in USD for an equivalent amount (including conversion fees) of the particular cryptocurrency. The managing entity system 500 may then store that equivalent amount of the particular cryptocurrency in its account, or transfer at least a portion of that particular cryptocurrency amount to a managed digital wallet of a second user that previously owned the set of blockchain tokens.

Another possible managing entity application 550 may comprise a blockchain network application that is configured to access the blockchain network, publish new blocks to the blockchain network (e.g., blocks comprising transaction instructions, transaction confirmations, blockchain token balance information, blockchain token ownership information, and the like), validate blocks in the blockchain network, and the like. In some such embodiments, the managing entity data 552 associated with the blockchain network application may contain a copy of the distributed ledger of the blockchain network that is continuously updated and verified based on other nodes within the blockchain network.

Furthermore, a possible managing entity application 550 may comprise a cryptography application configured to encrypt and decrypt private and public keys associated with a blockchain network for managed digital wallets. For example, the cryptography application may be configured to receive a confidential passcode (e.g., a personal identification number) of a user 410, and encrypts the private and/or public key associated with the blockchain network using the confidential passcode of the user 410. In this way, the managing entity system 500 can control and manage the digital wallet of the user 410, and only requires that the user 410 enter the confidential passcode to execute a transaction of blockchain tokens instead of requiring the user 410 to manage its own digital wallet and remember (or securely store) the complex and long private or public key. Instead, the cryptography application receives the confidential passcode of the user 410, applies a blockchain network key algorithm to the confidential passcode (which may include additional information), and identifies the private and/or public key of the user 410 that can be used in the execution of a transaction of blockchain tokens.

One managing entity application 550 may, in some embodiments, comprise a token exchange application that is configured to facilitate an environment for the buying and selling of blockchain tokens associated with physical assets, internally within the managing entity system 500 and/or through a third party exchange system. In embodiments with a third party exchange system (e.g., a third party system 430), the token exchange application may be configured to present one or more application program interfaces to the third party exchange system that provide user authentication, user and transaction validation, transaction confirmation, and other processes, when prompted or engaged by the third party exchange system.

The network server application 540 and the managing entity applications 550 are configured to invoke or use the managing entity data 552, and the like when communicating through the network communication interface 510 with the computing device systems 600, the central authority repository 420, and/or the one or more third party systems 430.

FIG. 6 provides a block diagram illustrating a computing device system 600 of FIG. 1 in more detail, in accordance with embodiments of the invention. The computing device system 600 may comprise one or more computing devices including, but not limited to personal computers, mobile devices, portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 600 include a processor 610 communicably coupled to such devices as a memory 620, user output devices 636, user input devices 640, a network interface 660, a power source 615, a clock or other timer 650, a camera 680, and a positioning system device 675. The processor 610, and other processors described herein, generally include circuitry for implementing communication and/or logic functions of the computing device system 600. For example, the processor 610 may include a digital signal processor device, a microprocessor device, and various analog to digital converters, digital to analog converters, and/or other support circuits. Control and signal processing functions of the computing device system 600 are allocated between these devices according to their respective capabilities. The processor 610 thus may also include the functionality to encode and interleave messages and data prior to modulation and transmission. The processor 610 can additionally include an internal data modem. Further, the processor 610 may include functionality to operate one or more software programs, which may be stored in the memory 620. For example, the processor 610 may be capable of operating a connectivity program, such as a web browser application 622. The web browser application 622 may then allow the computing device system 600 to transmit and receive web content, such as, for example, location-based content and/or other web page content, according to a Wireless Application Protocol (WAP), Hypertext Transfer Protocol (HTTP), and/or the like.

The processor 610 is configured to use the network interface 660 to communicate with one or more other devices on the network 450. In this regard, the network interface 660 includes an antenna 676 operatively coupled to a transmitter 674 and a receiver 672 (together a “transceiver”). The processor 610 is configured to provide signals to and receive signals from the transmitter 674 and receiver 672, respectively. The signals may include signaling information in accordance with the air interface standard of an applicable cellular system of the network 450. In this regard, the computing device system 600 may be configured to operate with one or more air interface standards, communication protocols, modulation types, and access types. By way of illustration, the computing device system 600 may be configured to operate in accordance with any of a number of first, second, third, and/or fourth-generation communication protocols and/or the like. For example, the computing device system 600 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 6GPP protocols and/or the like. The computing device system 600 may also be configured to operate in accordance with non-cellular communication mechanisms, such as via a wireless local area network (WLAN) or other communication/data networks.

As described above, the computing device system 600 has a user interface 630 that is, like other user interfaces described herein, made up of user output devices 636 and/or user input devices 640. The user output devices 636 include a display 634 (e.g., a liquid crystal display or the like) and a speaker 632 or other audio device, which are operatively coupled to the processor 610.

The user input devices 640, which allow the computing device system 600 to receive data from a user such as the user 410, may include any of a number of devices allowing the computing device system 600 to receive data from the user 410, such as a keypad, keyboard, touch-screen, touchpad, microphone, mouse, joystick, other pointer device, button, soft key, and/or other input device(s). The user interface may also include a camera 680, such as a digital camera.

The computing device system 600 may also include a positioning system device 675 that is configured to be used by a positioning system to determine a location of the computing device system 600. For example, the positioning system device 675 may include a GPS transceiver. In some embodiments, the positioning system device 675 is at least partially made up of the antenna 676, transmitter 674, and receiver 672 described above. For example, in one embodiment, triangulation of cellular signals may be used to identify the approximate or exact geographical location of the computing device system 600. In other embodiments, the positioning system device 675 includes a proximity sensor or transmitter, such as an RFID tag, that can sense or be sensed by devices known to be located proximate a merchant or other location to determine that the computing device system 600 is located proximate these known devices.

The computing device system 600 further includes a power source 615, such as a battery, for powering various circuits and other devices that are used to operate the computing device system 600. Embodiments of the computing device system 600 may also include a clock or other timer 650 configured to determine and, in some cases, communicate actual or relative time to the processor 610 or one or more other devices.

The computing device system 600 also includes a memory 620 operatively coupled to the processor 610. As used herein, memory includes any computer readable medium (as defined herein below) configured to store data, code, or other information. The memory 620 may include volatile memory, such as volatile Random Access Memory (RAM) including a cache area for the temporary storage of data. The memory 620 may also include non-volatile memory, which can be embedded and/or may be removable. The non-volatile memory can additionally or alternatively include an electrically erasable programmable read-only memory (EEPROM), flash memory or the like.

The memory 620 can store any of a number of applications which comprise computer-executable instructions/code executed by the processor 610 to implement the functions of the computing device system 600 and/or one or more of the process/method steps described herein. For example, the memory 620 may include such applications as a conventional web browser application 622 and/or a managing entity portal application 621 (or any other application provided by the managing entity system 500). These applications also typically instructions to a graphical user interface (GUI) on the display 634 that allows the user 410 to interact with the computing device system 600, the managing entity system 500, and/or other devices or systems. In one embodiment of the invention, when the user 410 decides to enroll in a managing entity portal application 621 program, the user 410 downloads, is assigned, or otherwise obtains the managing entity portal application 621 from the managing entity system 500, or from a distinct application server (e.g., from a third party system 430). In other embodiments of the invention, the user 410 interacts with the managing entity system 500 via the web browser application 622 in addition to, or instead of, the managing entity portal application 621.

The memory 620 of the computing device system 600 may comprise a Short Message Service (SMS) application 623 configured to send, receive, and store data, information, communications, alerts, and the like via the wireless telephone network 152.

The managing entity portal application 621 may be configured to allow the user 410 associated with the computing device system 600 to interact with the managing entity system 500. As such, the managing entity portal application 621 may be configured to cause the display 634 of the user interface 630 to present information to the user 410, prompt the user 410 for user input (e.g., using the user input devices 640), receive user input from the user 410, and the like, to facilitate one or more of the process steps described herein. In some embodiments, the managing entity portal application 621 may store information associated with a digital wallet of the user 410 on the computing device system (e.g., one or more account balances, ownership interest information of one or more blockchain tokens that represent an ownership interest in a physical asset, and the like).

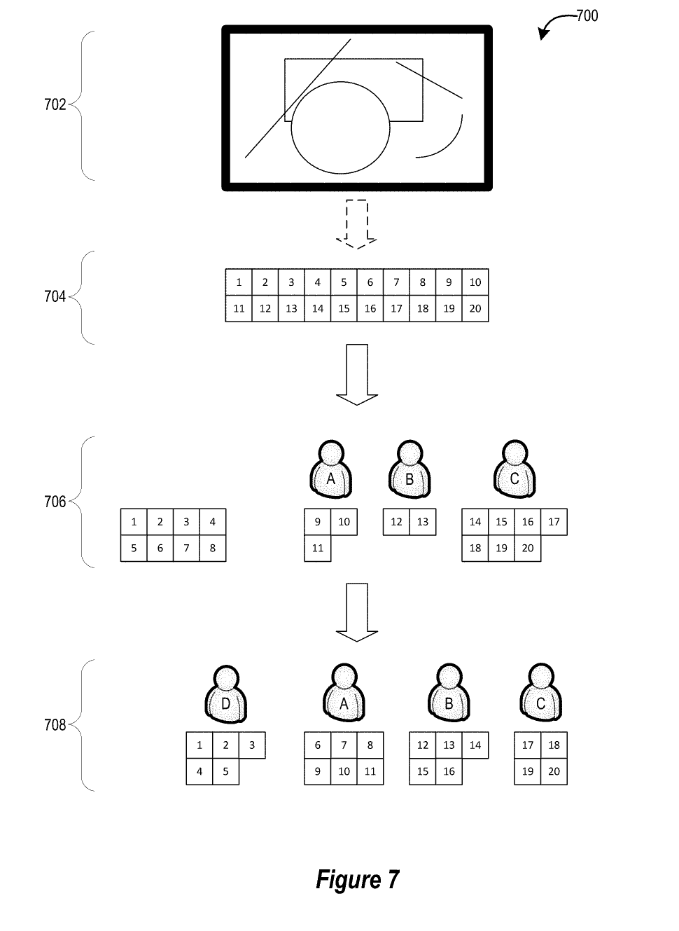

Referring now to FIG. 7, a flowchart is provided to illustrate one embodiment of a process 700 for generating and transferring blockchain tokens that represent an ownership interest in a physical asset in accordance with an embodiment of the invention.

Element 702 represents an acquisition of a physical asset (e.g., an artwork) by a managing entity (e.g., an entity that owns or otherwise operates the managing entity system 500). The physical asset may be any product, artwork, machine, real estate, or any other tangible asset. The physical asset may be purchased for a certain price, and may have an intrinsic value that is based on the purchased price, a set price, or a market-determined price.

As shown at element 704, the managing entity can generate a plurality of virtual tokens in the form of blockchain tokens (represented as blocks 1-20) that represent an ownership interest in the physical asset of element 702. Using the example at element 704, the managing entity has generated 20 blockchain tokens, so each blockchain token represents a 1/20^{th} interest in the physical asset. The generation of the blockchain tokens may be based on a smart contract, such that a standard set of rules and requirements for a transaction of one or more of the blockchain tokens must be met for the transaction to be executed by the smart contract. As such, blockchain networks like Ethereum that are designed for the generation and implementation of smart contracts (beyond being purely cryptocurrency-based) are especially useful in the process steps described herein. The generation of these blockchain tokens, the smart contract information, and other information (e.g., ownership of each blockchain token) can be recorded in the blockchain network's distributed ledger for accurate and validated ownership and transaction history records. At this stage, in element 704, the managing entity maintains ownership of the blockchain tokens 1-20. While only 20 representative blockchain tokens are shown in FIG. 7, it should be known that the managing entity can generate any number of blockchain tokens to serve as representations of fractional ownership of a physical asset. For example, the managing entity may generate hundreds of thousands of blockchain tokens. While not shown, the managing entity may generate additional blockchain tokens to dilute the ownership of the physical asset, such that the managing entity can sell those additional blockchain tokens to cover management expenses and the like, according to a predetermined agreement with all users that register to purchase the blockchain tokens.

Next, the managing entity may distribute at least a portion of the blockchain network tokens to one or more users, as shown at element 706. The managing entity system may distribute the tokens to the users in return for a payment based on the fractional value of the physical asset represented by each blockchain token. In some embodiments, this initial distribution may be an initial coin offering (“ICO”) that may be public (available to any user, or any registered user) or private (available to a particular group of users and/or entities). As shown in the example at element 706, the managing entity system distributed tokens 9-20 to users A, B, and C, and continues to maintain ownership of blockchain tokens 1-8.

Over time, the value of the physical asset may change (e.g., appreciation and other market conditions), thereby changing the value of the underlying blockchain tokens that represent the fractional ownership interests in the physical asset. The managing entity and the users that own the blockchain tokens can trade, sell, buy, or otherwise exchange blockchain tokens with each other and new users over time. These trades can be managed by the managing entity through an internal exchange, and/or by an external third party exchange system. As an example, element 708 illustrates a future point in time, where the managing entity system has sold its blockchain tokens 1-5 to a new user D, the managing entity system has traded blockchain tokens 6-8 to user A, and user C has traded blockchain tokens 14-16 to user B. Each of these transfers of the blockchain tokens would have been made in return for a payment amount (e.g., in USD, in a particular cryptocurrency, or the like) that was based on the fractional value of each blockchain token at the time the transaction was made.

At the point in time associated with element 708, user A has a 3/10 ownership in the physical asset, user B has a ¼ ownership in the physical asset, user C has a ⅕ ownership in the physical asset, and user D has a ¼ ownership in the physical asset. As such, if the physical asset is sold (e.g., as permitted by a majority vote of users A-D or based on an agreement either built into the smart contract or established by the users A-D), then each user A-D would receive a payout proportional to their respective ownership share.

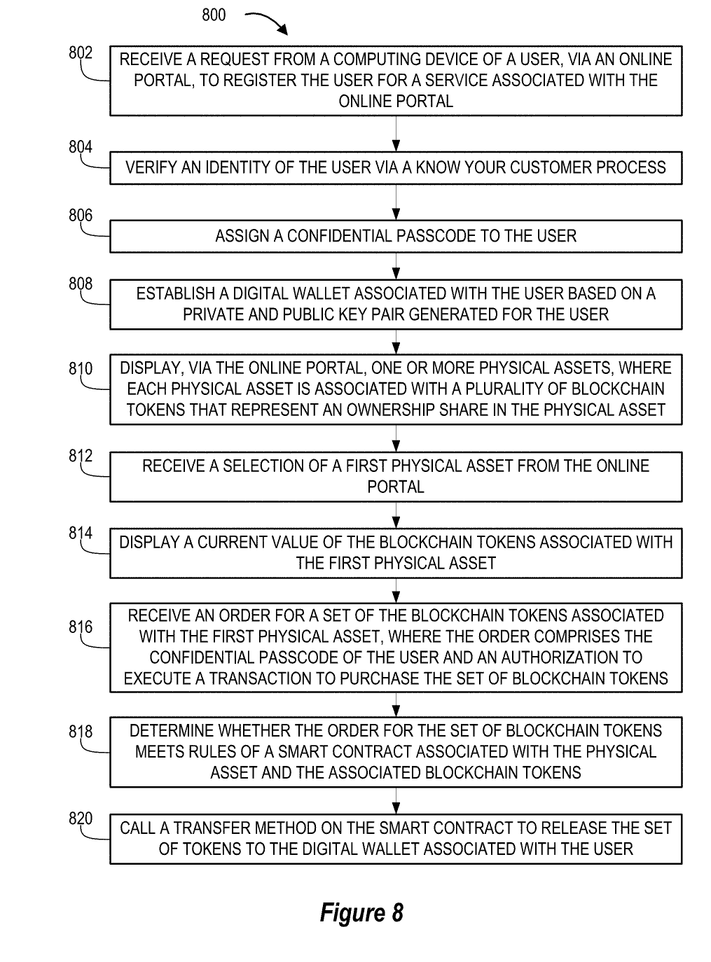

Referring now to FIG. 8, a flowchart is provided to illustrate one embodiment of a process 800 for generating and transferring blockchain tokens that represent an ownership interest in a physical asset in accordance with an embodiment of the invention. In some embodiments, the process 800 may include block 802, where the system receives a request from a computing device of a user, via an online portal, to register the user for a service associated with the online portal. As noted with respect to FIG. 7 above, a managing entity system associated with this process 800 may have acquired a physical asset like an artwork and generated a plurality of blockchain tokens that adhere to a smart contract within the associated blockchain network to represent a fractional ownership stake in the physical asset. The managing entity may then begin to sell these blockchain tokens to individual investors (or “users”). In some embodiments the initial transfer of at least a portion of the blockchain tokens associated with the physical asset is part of an initial coin offering, an initial blockchain token offering, or the like.

To enable proper regulation of the ownership of the blockchain tokens that represent a financial stake in the physical asset, the managing entity system must maintain full knowledge of the identity of the blockchain tokens' owners, these owners' positions with respect to the asset (e.g., ownership stake), and other regulatory information. Therefore, in some embodiments, the process 800 includes block 804, where the system verifies an identity of the user via a “know your customer” (“KYC”) process, before any blockchain tokens are issued to the user. The system may require additional information about the user that is normally required by regulatory and tax agencies. In this way, the system ensures that all users that register for the services described herein are fully known to the managing entity system, and information about these users is continuously monitored. The user information, including contact information, account information, residency information, citizenship information, and the like, may all be stored in a central authority repository that is continuously monitored and updated over time.

Therefore, the users are not anonymous to the managing entity or any regulatory body whose rules or regulations govern the ownership and/or transfer of blockchain tokens associated with physical assets. Instead, the users with information stored in the central authority repository may be considered vetted users, especially once the information has been analyzed by the managing entity and/or a third party regulatory agency for the purpose of allowing each individual user to participate in the transactions described herein. The central authority repository therefore comprises a listing of vetted users that are each permitted to perform transactions of blockchain tokens associated with a physical asset.

Additionally, in some embodiments, the process 800 includes block 806, where the system assigns a confidential passcode to the user. This confidential passcode may comprise a personal identification number (PIN), a password, a randomly generated code, or any other secure method for authenticating the owner. In some embodiments, the user provides their own personal identification number or confidential passcode.

The process 800 may also include block 808, where the system establishes a digital wallet associated with the user based on a private and public key pair generated for the user. In some embodiments, the system establishes these private and/or public keys based on the confidential passcode (e.g., by running the confidential passcode through one or more algorithms that generate the private and public key pair). In some embodiments, the managing entity system manages the digital wallet of each of its users to ensure that any transactions associated with the blockchain tokens pegged to the physical asset are fully controlled by the managing entity system and are performed in a manner that is approved by regulatory agencies. In this way, a user can submit requests to the managing entity system for the purchase, sale, or other transfer of the one or more blockchain tokens associated with the physical asset, where the submitted request includes the confidential passcode of that user as an authentication tool for confirming the identity and intentions of the user.

In some embodiments, the process 800 includes block 810, where the system displays, via the online portal, representations (e.g., selectable icons) of one or more physical assets, where each physical asset is associated with a plurality of blockchain tokens that represent an ownership share in the physical asset. As noted above, each of these physical assets may be acquired by the managing entity, and the managing entity may have generated the blockchain tokens that represent ownership stakes in each physical asset. Displaying physical assets may comprise displaying icons, images, text, or any other selectable indicia of the physical assets. In some embodiments, the displayed physical assets may be representations of portions of an overall physical asset. For example, an image of an artwork may be displayed, along with a portion of the artwork that is available for sale, a unit amount (i.e., a number of ownership units that are available for that artwork, a current or estimated price for an individual ownership unit of the artwork, a current or estimated price for a set of individual ownership units of the artwork, or the like).

Additionally, in some embodiments, the process 800 includes block 812, where the system receives a selection of a first physical asset from the online portal. This selection represents the user's interest and/or intention to purchase one or more of the blockchain tokens associated with that physical asset. The selection may be made by the user pressing, clicking on, or otherwise selecting an icon associated with the first physical asset (e.g., an image of the artwork or a portion of the artwork) within the online portal. The first physical asset is a representation of a specific portion (e.g., percentage, amount, ratio, or the like) of the artwork that the user is selecting. For example, in FIG. 7, user A may have selected a first physical asset comprising three units (i.e., blocks 9, 10, and 11) at element 706. The physical asset in that case may comprise the set of the three blocks 9, 10, and 11.

The process 800 may then include block 814, where the system displays a current value of the blockchain tokens associated with the first physical asset. This current value may comprise a common currency type (e.g., USD), or a cryptocurrency value (e.g., ether, bitcoin, or the like) for which the managing entity is willing to sell each blockchain token associated with the physical asset. This value may be based on the proportional value of the physical asset, and may include additional administration, insurance, marketing, security, or other fees that the managing entity system is required to perform to acquire and care for the actual physical asset. In some embodiments, the managing entity system may discount an initial set of blockchain tokens for early adapters, early investors, other entities that are associated with the acquisition of the physical asset, or the like. The displayed value may comprise a total value for the overall first physical asset, a value per unit of several units that make up the first physical asset, or the like.

Furthermore, the process 800 may include block 816, where the system receives an order for a set of the blockchain tokens associated with the first physical asset, where the order comprises the confidential passcode of the user and an authorization to execute a transaction to purchase the set of blockchain tokens. As noted above, the managing entity system will require the confidential passcode of the user to authenticate the purchasing user. The managing entity system may also compare information provided by the user in the purchase order to information stored in the central repository to ensure that the user's identity is authenticated, that the user is authorized to receive the blockchain tokens (based on rules or requirements of regulatory agencies and/or the managing entity system itself), and the like. In this way, the managing entity system ensures that all users that will receive the blockchain tokens associated with the physical asset are fully known and vetted for regulatory issues at the time of disbursement.

Additionally, the confidential passcode may, in some embodiments, allow the managing entity system to identify or otherwise determine the public key associated with the user's managed blockchain wallet so that the requested blockchain tokens can be transferred to the correct wallet. In some embodiments, the purchase order may include a payment (e.g., in USD, in a cryptocurrency coin amount, or the like) from the user.

Receiving the order for the set of blockchain tokens associated with the first physical asset may involve receiving a user selection, via the online portal (or a mobile application on a mobile device of the user), of an icon representing the first physical asset, the number of available units that make up the first physical asset, the total price for the overall first physical asset, the price for each individual unit that makes up the first physical asset, and/or a box or other representation that represents the user's intention to acquire the first physical asset (or one or more of the units that makes up the first physical asset) for the displayed price. Furthermore, one or more of the selectable icons, or information associated with those selectable icons, may inform the user that this transaction will involve the acquisition of blockchain tokens that represent the first physical asset.

In some embodiment, the process 800 may include block 818, where the system determines whether the order for the set of blockchain tokens meets rules of a smart contract associated with the physical asset and the associated blockchain tokens. As described herein, the smart contract may be a computer protocol that establishes and facilitates the performance of agreed-upon transactions and transaction rules between certain parties. The smart contract governs the requirements for initiating, executing, and verifying the transfer of blockchain tokens between digital wallets of two users (e.g., the user and a second user from whom the user is purchasing the blockchain tokens from, or the user and a managing entity or other party that has ownership of the blockchain tokens that are being acquired). This smart contract may additionally include rules for when or how the managing entity is permitted to exchange blockchain tokens between digital wallets of two or more users, where the managing entity has control over these digital wallets. If any of the standards or requirements set by the smart contract are not met, then the system may reject the transaction and transmit a message back to the user (e.g., via the online portal) to inform the user of the terminated transaction.

Once the system determines that the requested purchase order is valid, the process 800 may continue to block 820, where the system calls a transfer method on the smart contract to release the set of tokens to the digital wallet associated with the user. This step may comprise building a transfer method or function based on the requested transfer of blockchain tokens to the digital wallet of the user, and publishing the transfer function to the blockchain network such that the smart contract stored on the blockchain network automatically verifies the built transfer function and releases the blockchain tokens from a digital wallet associated with the managing entity to the managed digital wallet of the user. The user now has the requested number of blockchain tokens associated with the physical asset in the managed digital wallet of the first user.

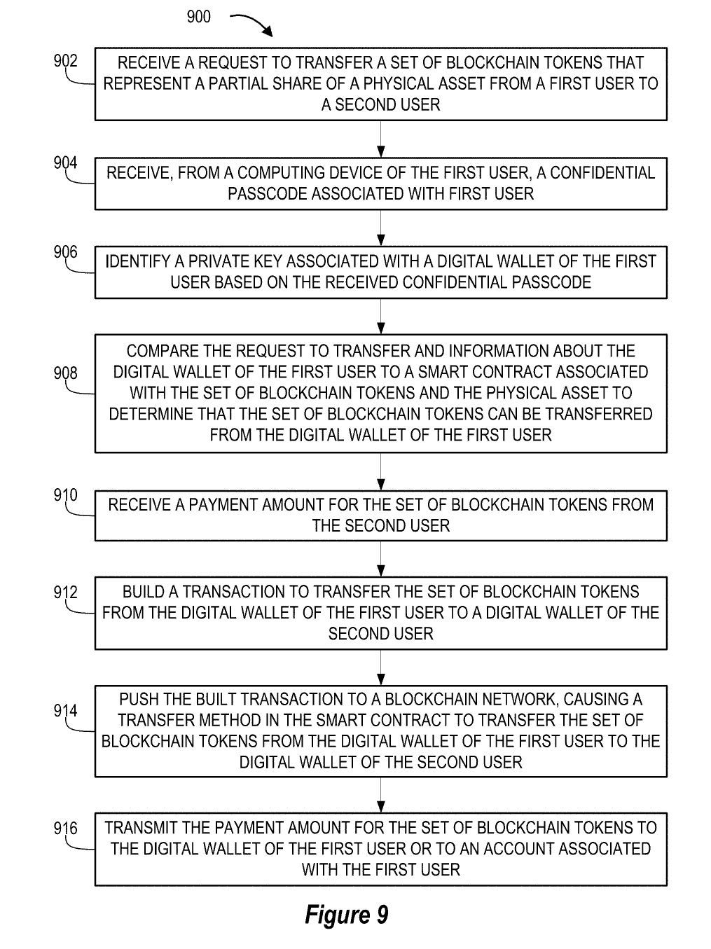

Referring now to FIG. 9, a flowchart is provided to illustrate one embodiment of a process 900 for facilitating a transfer of blockchain tokens between two users in accordance with an embodiment of the invention. In some embodiments, the process 900 may include block 902, where the system receives a request to transfer a set of blockchain tokens that represent a partial share of a physical asset from a first user to a second user. As noted above with respect to FIG. 8, the managing entity associated with the system in this process 900 may provide an online portal that registered users can access to submit transfer requests for blockchain tokens associated with ownership shares of physical assets. Therefore, this block 902 may comprise receiving a transfer request from a first and/or second user, via the online portal.

The transfer request, and any requests, inputs, selections, or the like that are described herein, that are received by the system may comprise an indication that the user has selected an icon, button, or the like on a user interface that facilitates the user's interaction with the managing system. For example, the system may have displayed transaction request fields (e.g., an artwork that the user may purchase a portion of, an amount the user would like to spend, personal information about the user, a requested timing of the transaction, authentication credentials for the user, and the like) as well as a selectable transaction request submission button, link, or icon that the user can click, press, or the like to submit the transaction request. This transaction request, and the associated information, is then transmitted to the system.

In some embodiments, the process 900 includes block 904, where the system receives, from a computing device of the first user, a confidential passcode associated with the first user. Block 904 may include receiving additional information associated with the first user such that the managing entity system can authenticate the identity of the first user and/or ensure that the first user meets all regulatory requirements for transferring the blockchain tokens from a managed digital wallet associated with the first user.

Additionally, in some embodiments, the process 900 includes block 906, where the system identifies a private key associated with a digital wallet of the first user based on the received confidential passcode. Again, the private key may be ascertained based on the received confidential passcode in embodiments where the private and public key pair are generated based on the confidential passcode. In other embodiments, the managing entity system may compare the received confidential passcode to a database maintained by the managing entity system that comprises user information and associated private and/or public keys. By identifying the private key associated with the managed digital wallet of the first user, the managing entity system will be able to build a transfer method or function that a smart contract stored in the blockchain database will execute to transfer blockchain tokens from the managed digital wallet of the first user.

The process 900 may also include block 908, where the system compares the request to transfer and information about the digital wallet of the first user to a smart contract associated with the set of blockchain tokens and the physical asset to determine that the set of blockchain tokens can be transferred from the digital wallet of the first user. Additionally, the managing entity system will compare information received from the second user, including identification information, a confidential passcode, a public key associated with the managed digital wallet of the second user (to which the requested set of blockchain tokens will be transferred), and any other information required for regulatory purposes, to information stored in the central authority repository to confirm whether the transaction will meet the regulatory requirements. This step will also enable the managing entity system to identify any potential errors or additional information that is needed from the first or second user prior to publishing the transaction of the blockchain tokens to the blockchain network.

In some embodiments, the process 900 includes block 910, where the system receives a payment amount for the set of blockchain tokens from the second user. Again, this payment amount may be in the form of traditional currency (e.g., USD) or in the form of a cryptocurrency coin (e.g., ether, bitcoin, and the like).

Once the payment amount has been received from the second user, the process 900 may proceed to block 912, where the system builds a transaction to transfer the set of blockchain tokens from the digital wallet of the first user to a digital wallet of the second user. As described herein, the blockchain token transaction may be built based on one or more smart contracts and/or in response to confirming that all requirements of associated smart contracts have been satisfied.

The process 900 may then include block 914, where the system pushes the built transaction to a blockchain network, causing a transfer method in the smart contract to transfer the set of blockchain tokens from the digital wallet of the first user to the digital wallet of the second user. The second user's balance of blockchain tokens associated with the physical asset is now updated to include the transferred set of blockchain tokens.

Finally, the process 900 may continue to block 916, where the system transmits the payment amount for the set of blockchain tokens to the digital wallet of the first user or to an account associated with the first user, thus completing the trade. As described herein, the managing entity's system manages each of the first and second users' digital wallets (and therefore the blockchain tokens stored therein), and is therefore the party that executes the transmission(s) of blockchain tokens between the respective digital wallets.

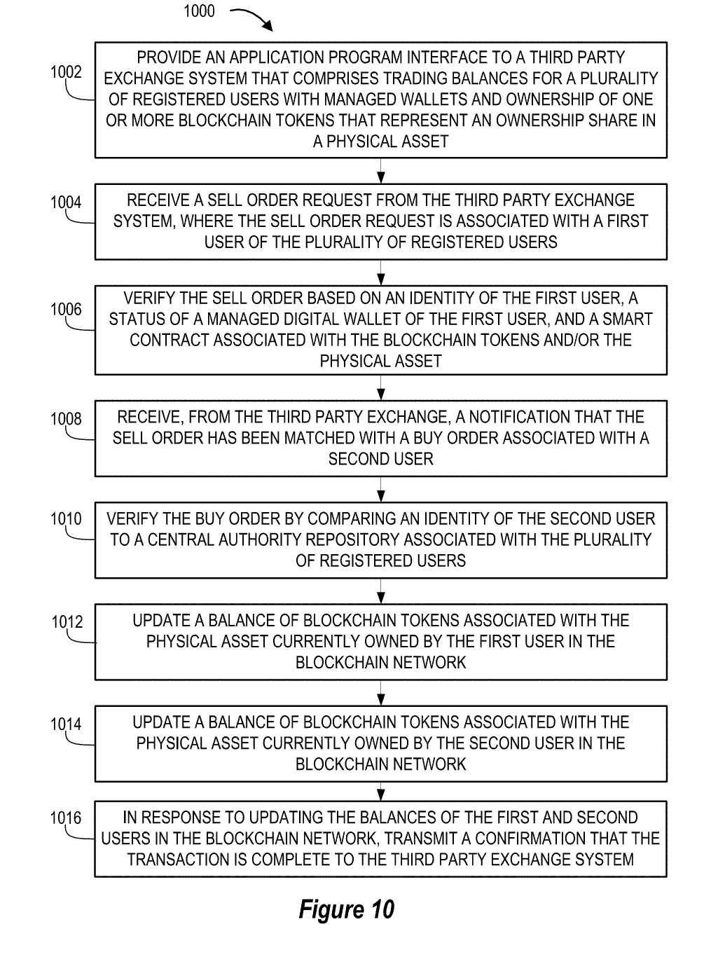

Referring now to FIG. 10, a flowchart is provided to illustrate one embodiment of a process 1000 for facilitating a transfer of blockchain tokens via a third party exchange system in accordance with an embodiment of the invention. In some embodiments, the process 1000 may include block 1002, where the system provides an application program interface to a third party exchange system that comprises trading balances for a plurality of registered users with managed wallets and ownership of one or more blockchain tokens that represent an ownership share in a physical asset. The application program interface permits the third party exchange system to view how many blockchain tokens associated with the physical asset are available for registered users to trade.

In some embodiments, the third party exchange may require that blockchain tokens be designated for trading within their particular exchange. In such embodiments, a user may request a designation of a certain number of their blockchain tokens associated with the physical asset to be traded via the third party exchange. The managing system does not actually transfer these tokens to the third party exchange system, or to digital wallets of the third party exchange system. Instead, the managing system records the designation of the requested number of blockchain tokens as being tradeable within the third party exchange, where the recordation occurs on the designated ledger within the associated blockchain network (e.g., according to rules and requirements of a smart contract). The application program interface made available to the third party exchange system includes an endpoint with this information about how many blockchain tokens are designated for transfer through the third party exchange.

Each user may trade blockchain tokens for the same physical asset through multiple third party exchanges (and/or an internal exchange of the managing entity). Additionally or alternatively, a user may trade blockchain tokens associated with different physical assets (e.g., two separate paintings) within the same third party exchange.

The third party exchange provides listings of the blockchain tokens, including information about ownership interest amounts in the associated physical assets, and values of the blockchain token for buyers and/or sellers of the blockchain tokens. These values may be in the form of US dollars, a foreign currency, a cryptocurrency, or the like. As such, a user with blockchain tokens listed on a third party exchange can view the current value of blockchain tokens associated with the particular physical asset and request to transfer (i.e. buy or sell) one or more of the blockchain tokens through the exchange.

Once the user submits a transfer request (e.g., a sell order, a buy order, a trade order, or the like) in the third party exchange, the third party exchange will interact with an application program interface provided by the managing entity. As such, the process 1000 may include block 1004, where the system receives a sell order request from the third party exchange system, where the sell order request is associated with a first user of the plurality of registered users. The sell order request may include the number of blockchain tokens that the first user would like to sell (i.e., the set of blockchain tokens to be sold), the transaction value and/or price of the set of blockchain tokens, a confidential passcode (e.g., a personal identification number) associated with the first user and/or a digital wallet of the first user that is managed by the managing entity, other user authentication information, and the like. Again, this sell order request may be received via an application program interface made available to the third party exchange system by the managing entity system.

Once the sell order request has been received, the process 1000 may proceed to block 1006, where the system of the managing entity verifies the sell order based on the identity of the first user, a status of a managed digital wallet of the first user, and a smart contract associated with the blockchain tokens and/or the physical asset. The identity of the user may be checked against a whitelist or other record of registered and vetted users that are permitted to own and/or trade the blockchain tokens associated with the physical asset. The status of the managed digital wallet of the first user is checked to ensure that the first user does have the requisite blockchain tokens to exchange. This check of the managed digital wallet of the first user may additionally include a check to ensure that the digital wallet of the first user would include a permissible amount of blockchain tokens after the requested sell order is executed. For example, the system may require that each user have either no blockchain tokens associated with the physical asset, have blockchain tokens that amount to a particular minimum percent ownership in the physical asset, and/or a particular minimum currency value of owned blockchain tokens associated with the physical asset. If the managed digital wallet of the first user meets these criteria, then the managing entity system can verify that the first user's digital wallet is authorized to transfer out or otherwise sell the requested blockchain tokens associated with the physical asset.

The managing entity compares the requested sell order against the smart contract or other central authority that establishes rules or requirements for the blockchain tokens that represent an ownership share in the physical asset to ensure that the request order meets these rules and requirements. In some embodiments, the smart contract is built into the blockchain network such that a transfer function of the smart contract automatically executes a transfer of the blockchain tokens from the managed digital wallet of the first user to another location. This other location may comprise a digital wallet escrow account location, a digital wallet associated with the managing entity or the third party exchange system (to be held until a purchase order is received), or the like.

The process 1000 may also include block 1008, where the system receives, from the third party exchange, a notification that the sell order has been matched with a buy order associated with a second user. While a single buy order and a single sell order are referenced in this FIG. 10, it should be known that any number of buy or sell orders, and any portions of a single buy or sell order can be matched with other buy and sell orders or fractions of buy and sell orders, such that each blockchain token that is sold is also bought. In some embodiments, the managing entity receives the blockchain tokens associated with the physical asset before transferring the blockchain tokens associated with the physical asset to a digital wallet of a purchaser. The managing entity system and/or the third party exchange system may maintain a digital wallet with a plurality of blockchain tokens associated with the physical asset at all times as a buffer to permit automatic or near real-time purchases of the blockchain tokens.

The received buy order may comprise an identity of the second user, a confidential passcode (e.g., a personal identification number) associated with the second user, a public key associated with a managed digital wallet of the second user, or the like. As described above, in some embodiments, the confidential passcode of the second user can be used by the managing entity system to derive or otherwise determine a public or private key associated with a managed digital wallet of the second user that will be receiving the transferred blockchain tokens associated with the physical asset. The system of the managing entity and/or the third party exchange may perform one or more verification and/or authentication steps to determine the identity of the second user, request additional information from the user, or the like.

In some embodiments, the process 1000 includes block 1010, where the system verifies the buy order by comparing an identity of the second user to a central authority repository or a whitelist associated with the plurality of registered users that are authorized to purchase blockchain tokens. By maintaining the central authority repository that comprises the list of users that are registered, vetted, and/or otherwise have been granted permission to participate in the exchange of the blockchain tokens associated with the physical asset, the managing entity system ensures that the owners of physical asset (i.e., the owners of the blockchain tokens that are representative of ownership shares of the overall physical asset) remain identified, can be contacted if a potential purchaser of the underlying physical asset is identified, can be included in audit reports or other reports to government agencies that regulate public or semi-public exchanges, and the like. Without the central authority repository, the blockchain tokens associated with the physical asset could be freely traded to parties that are not permitted to purchase such assets on the public or semi-public exchanges. Additionally, the lack of a central authority repository would allow for purchasers of the blockchain tokens to remain anonymous, which would make it impossible to report for regulated exchange purposes, tax purposes, securities malfeasance purposes, and the like. Therefore the use of a continuously maintained central authority repository, and the requirement that all owners of the blockchain tokens associated with the physical asset are included in the central authority repository, with all information required by regulatory and tax agencies, ensures a safe, secure, and legal exchange practice.

As with the first user (the seller), the managing entity system may additionally check the balance of the managed digital wallet of the second user to determine whether a permitted number or value of blockchain tokens associated with the physical asset will be stored in the managed digital wallet of the second user after the transfer. For example, the managing entity system may restrict that each individual owner of blockchain tokens associated with the physical asset to an ownership amount (i.e., number of blockchain tokens), ownership amount (i.e., value of the blockchain tokens), and/or an ownership percent (e.g., percentage of issued blockchain tokens associated with the physical asset, percentage ownership of the overall physical asset, or the like). Once the managing entity system has determined that the managed digital wallet of the second user will remain within the requirements of the system after the requested buy order is executed, the managing entity system can verify the managed digital wallet for the transaction.

Once the sell order has been verified, the process 1000 can proceed to block 1012, where the system updates a balance of blockchain tokens associated with the physical asset currently owned by the first user in the blockchain network. Updating the balance may comprise drafting a transfer function of the number of blockchain tokens associated with the physical asset from the managed digital wallet of the first user to a holding digital wallet of the managing entity and/or the third party exchange system, or a transfer to the managed digital wallet of the second user. This transfer function may then be published on the blockchain such that the smart contract (or other program established with rules and requirements for the blockchain tokens) associated with the blockchain tokens and/or the physical asset automatically confirms the validity of the transaction and executes the transfer function.

Similarly, and in some embodiments, simultaneously, the process 1000 may include block 1014 where the system updates a balance of blockchain tokens associated with the physical asset currently owned by the second user in the blockchain network. Again, a transfer function comprising the number of blockchain tokens associated with the physical asset that are to be transferred to the managed digital wallet of the second user from the digital wallet of the first user and/or from a digital wallet of the managing entity system or third party exchange system. The transfer function can then be published to the blockchain network for execution by the smart contract.

Finally, in response to updating the balances of the first and second users in the blockchain network, the process 1000 may continue to block 1016, where the system transmits a confirmation that the transaction is complete to the third party exchange system. As the actual transaction takes place within (or by) the managing entity system, the managing entity system must transmit this confirmation (e.g., via an application program interface) to the third party exchange system so the third party exchange system can update its records, record the transfer(s), and the like. Additionally, the balances of the digital wallets of both the first user and the second user are updated by the managing entity system such that the third party exchange system can monitor the balances through the one or more application program interfaces provided by the managing entity system.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for central authority-permissioned transfer of blockchain tokens, the system comprising:
a memory device; and
a processing device operatively coupled to the memory device, wherein the processing device is configured to execute computer-readable program code to:
receive a request to transfer a set of blockchain tokens that represent an ownership share in a physical asset from a first user to a second user;
compare information about the first user to a central authority repository that comprises a listing of vetted users permitted to perform transactions with blockchain tokens associated with the physical asset to determine that the first user is verified;
compare information about the second user to the central authority repository to determine that the second user is verified;
in response to determining that the first user is verified, and in response to determining that the second user is verified, build a transaction function for the transfer of the set of blockchain tokens from a digital wallet of the first user to a digital wallet of the second user; and
publish the transaction function to a blockchain network associated with the set of blockchain tokens.

2. The system of claim 1, wherein the request to transfer the set of blockchain tokens comprises a confidential passcode of the first user and a confidential passcode of the second user, wherein the confidential passcode of the first user is associated with a public and private key pair of the digital wallet of the first user, and wherein the confidential passcode of the second user is associated with a public and private key pair of the digital wallet of the second user.

3. The system of claim 1, wherein the digital wallet of the first user is managed solely by a central authority entity, and wherein the digital wallet of the second user is managed solely by the central authority entity.

4. The system of claim 1, wherein the request to transfer the set of blockchain tokens is received from a third party exchange system.

5. The system of claim 4, wherein the processing device is further configured to execute computer-readable program code to transmit a notification to the third party exchange system indicating that the set of blockchain tokens has been transferred from the digital wallet of the first user to the digital wallet of the second user.

6. The system of claim 1, wherein comparing the information about the first user to the central authority repository to determine that the first user is verified comprises determining that a received identity of the first user matches an identity of a vetted user stored within the central authority repository that meets regulatory requirements for trading the set of blockchain tokens.

7. The system of claim 1, wherein comparing the information about the second user to the central authority repository to determine that the second user is verified comprises determining that a received identity of the first user matches an identity of a vetted user stored within the central authority repository that meets regulatory requirements for trading the set of blockchain tokens.

8. A computer program product for central authority-permissioned transfer of blockchain tokens, the computer program product comprising at least one non-transitory computer readable medium comprising computer readable instructions, the instructions comprising instructions for:
receiving a request to transfer a set of blockchain tokens that represent an ownership share in a physical asset from a first user to a second user;
comparing information about the first user to a central authority repository that comprises a listing of vetted users permitted to perform transactions with blockchain tokens associated with the physical asset to determine that the first user is verified;
comparing information about the second user to the central authority repository to determine that the second user is verified;
in response to determining that the first user is verified, and in response to determining that the second user is verified, building a transaction function for the transfer of the set of blockchain tokens from a digital wallet of the first user to a digital wallet of the second user; and
publishing the transaction function to a blockchain network associated with the set of blockchain tokens.

9. The computer program product of claim 8, wherein the request to transfer the set of blockchain tokens comprises a confidential passcode of the first user and a confidential passcode of the second user, wherein the confidential passcode of the first user is associated with a public and private key pair of the digital wallet of the first user, and wherein the confidential passcode of the second user is associated with a public and private key pair of the digital wallet of the second user.

10. The computer program product of claim 8, wherein the digital wallet of the first user is managed solely by a central authority entity, and wherein the digital wallet of the second user is managed solely by the central authority entity.

11. The computer program product of claim 8, wherein the request to transfer the set of blockchain tokens is received from a third party exchange system.

12. The computer program product of claim 11, wherein the computer readable instructions further comprise instructions for transmitting a notification to the third party exchange system indicating that the set of blockchain tokens has been transferred from the digital wallet of the first user to the digital wallet of the second user.

13. The computer program product of claim 8, wherein comparing the information about the first user to the central authority repository to determine that the first user is verified comprises determining that a received identity of the first user matches an identity of a vetted user stored within the central authority repository that meets regulatory requirements for trading the set of blockchain tokens.

14. The computer program product of claim 8, wherein comparing the information about the second user to the central authority repository to determine that the second user is verified comprises determining that a received identity of the first user matches an identity of a vetted user stored within the central authority repository that meets regulatory requirements for trading the set of blockchain tokens.

15. A computer implemented method for central authority-permissioned transfer of blockchain tokens, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving a request to transfer a set of blockchain tokens that represent an ownership share in a physical asset from a first user to a second user;
comparing information about the first user to a central authority repository that comprises a listing of vetted users permitted to perform transactions with blockchain tokens associated with the physical asset to determine that the first user is verified;
comparing information about the second user to the central authority repository to determine that the second user is verified;
in response to determining that the first user is verified, and in response to determining that the second user is verified, building a transaction function for the transfer of the set of blockchain tokens from a digital wallet of the first user to a digital wallet of the second user; and
publishing the transaction function to a blockchain network associated with the set of blockchain tokens.

16. The computer implemented method of claim 15, wherein the request to transfer the set of blockchain tokens comprises a confidential passcode of the first user and a confidential passcode of the second user, wherein the confidential passcode of the first user is associated with a public and private key pair of the digital wallet of the first user, and wherein the confidential passcode of the second user is associated with a public and private key pair of the digital wallet of the second user.

17. The computer implemented method of claim 15, wherein the digital wallet of the first user is managed solely by a central authority entity, and wherein the digital wallet of the second user is managed solely by the central authority entity.

18. The computer implemented method of claim 15, wherein the request to transfer the set of blockchain tokens is received from a third party exchange system.

19. The computer implemented method of claim 18, further comprising transmitting a notification to the third party exchange system indicating that the set of blockchain tokens has been transferred from the digital wallet of the first user to the digital wallet of the second user.

20. The computer implemented method of claim 15, wherein comparing the information about the first user to the central authority repository to determine that the first user is verified comprises determining that a received identity of the first user matches an identity of a vetted user stored within the central authority repository that meets regulatory requirements for trading the set of blockchain tokens, and wherein comparing the information about the second user to the central authority repository to determine that the second user is verified comprises determining that a received identity of the first user matches an identity of a vetted user stored within the central authority repository that meets regulatory requirements for trading the set of blockchain tokens.
